(19) United States
(12) Patent Application Publication
(10) Pub. No.: US 2003/0050935 A1
(43) Pub. Date: Mar. 13, 2003

(54) System and method for searching an object catalog subject to a plurality of standards regimes

(76) Inventor: Dominika Spetsmann, Maynard, MA (US)

Correspondence Address: PHILIP KOENIG, PITTAS / KOENIG, P.O. BOX 980, WINCHESTER, MA, 01890, US

(21) Appl. No.: 09/949,346

(22) Filed: Sep. 7, 2001

(51) Int. Cl. G06F 17/30; G06F 15/16

(52) U.S. Cl. 707/104.1; 709/217

(57) ABSTRACT

A system and method for searching a catalog of objects that are subject to regulation by a plurality of different standards-setting regimes. The system and method employ a normalization table comprising a master list of manually developed terms selected to map common subject matter of said objects and of said plurality of standards-setting regimes. Tables comprising maps of said catalog of objects and said plurality of standards-setting regimes manually developed using said master list of terms permit linking any standard in any of said standards-setting regimes to any of said objects that concerns the subject matter of said standard.

### FIELD OF THE INVENTION

The invention concerns the field of computer search engines intended for use on-line via the internet. More particularly the invention concerns a search engine for searching a catalog of products that are subject to a plurality of standard-setting regimes, such as educational materials that are marketed to schools throughout the United States, for use in curricula that are subject to state-set educational standards.

### BACKGROUND OF THE INVENTION

A particular difficult searching problem exist with respect to products sold for use in highly regulated industries, where products are required to meet governmental or industry standards. This problem is heightened where the regulatory regime is state-based, and each of the fifty states has established its own regulatory regime over the activity at issue. Education provides a classic illustration of this problem.

Particularly over the last decade, increasing calls for accountability in public school education (“K-12 education”) have led to the development of standards against which educational efforts can be tested and measured. In the absence of a national curriculum standard, each of the 50 states has developed its own set of standards, and the resulting sets of standards vary widely in approach, specificity and formulation. Some state educational standards are based in whole or part on guidelines issued by national organizations such as the National Council of Teachers of Math (NCTM), the National Council of Teachers of English (NCTE), and/or the National Council of Teachers of Science (NSTA). Other states have developed educational standards solely on their own, while still other states have cobbled together standards by copying and adapting portions of standards other states.

All sets of state educational standards are lengthy and complex, each being comprised of hundreds of different standards, addressing both the different subject matters covered by public education, and grade levels from kindergarten to 12^{th} grade. Often, each individual standard is comprised of numerous subsidiary “strands,” sometimes as many as several dozens, and these strands may in turn themselves be comprised of numerous substrands.

In addition, all standards, strands and substrands are subject to change and updating, and it is typical for changes to be made periodically in the standards regime of most states. At the present time, for example, the National Council of Teachers of Mathematics has recently published so-called “Year 2000” guidelines, and these new guidelines are widely expected to result in substantial changes in the mathematics curriculum standards of most states.

Publishers of teaching materials that address state educational curricula face the ongoing problem of matching the educational content of their products to the curriculum standards of each state. To deal with this problem most such publishers adopt the laborious approach of matching the content of their educational products, on a state by state basis, to the curriculum standards. If and when the standards of any state are changed in any way, as occurs virtually on a yearly basis, the matching of each educational product to the standards of that state must be redone, on a product-by-product, standard-by-standard, strand-by-strand, substrand-by-substrand basis. Because this approach is very labor intensive, and thus very costly, publishers tend to limit such periodic re-matchings to their best-selling products and to those states having the largest student populations Organizations engaged in the marketing of a wide variety of products, such as resellers of teaching materials, have failed to devise a cost effective solution to this chronic problem. The sheer quantity of permutations involved, in terms of numbers of products times numbers of state standards times numbers of standard strands, etc., has rendered intractable the task of modifying educational standard matching tables as the standards are changed.

It is accordingly an objective of the present invention to provide a means for matching the curriculum standards of a plurality of standard-setting regimes, including states, other governmental bodies, and private industry groups, to the substantive content of educational products, including textbooks and educational software.

It is another object of the invention to provide a means for matching the substantive content of educational products to a plurality of curriculum standards regimes that is accessible to an on-line community of users.

It is a further objective of the invention to provide a means for efficiently modifying the aforesaid matchings of curriculum standards to the content of educational products upon the occurrence of changes in any of said standards and of subsidiary standard strands and substrands.

It is yet another objective of the invention to provide a means for allowing on-line users to search a results list of educational products, meeting the user's curriculum requirements, in order to identify those products within that results list that also meet a plurality of pedagogically pertinent criteria unrelated to substantive content.

### BRIEF DESCRIPTION OF THE INVENTION

A principal aspect of the invention is thus a method of permitting users to identify, in a catalog of items that are subject to a plurality of different, and changing, standard setting regimes, all items in the catalog that meet any selected standard of any one selected regime.

The method is performed by a computer system that implements a search engine that is accessible to a community of users.

The present invention particularly addresses and solves the problem, in the field of educational materials, of matching detailed descriptions of the product content of each of a large number of products to the standards promulgated in each of a plurality of standard-setting regimes, each such regime comprising a vast number of detailed standards, standard strands, and substrands of standard strands.

In the system and method of the present invention, a master list of terms pertinent to both the product contents and the applicable plurality of standards, standard strands and substrands, is created manually, through analysis of the subject matter of the pertinent standards regimes by persons having a good knowledge and understanding of the particular subject matter addressed. School curricula are traditionally divided into four principal subjects, namely Language Arts, Math, Science and Social Sciences. The states promulgate standards for the main divisions within each of these subjects, for example including “Speaking”, “Reading”, and “Writing” in the case of Language Arts. These standards are in turn structured into subcategories or grade ranges (“strands”) and finally into numerous “substrands” that prescribe the actual curriculum content. While all states standards differ to a greater or lesser extent, all seek to address the basic elements of a K-12 curriculum, such as Grammar Rules, Solving Fractions or Balancing Equations.

The present invention employs a manually developed “master list” of all the key curriculum concepts that flow into state educational standards, to serve as a normalization device among the plurality of state standards and the contents of educational materials.

Thus persons knowledgeable regarding the teaching of mathematics subject matter in the primary grades develop a master list of curriculum concept terms, or “skills” terms, sufficient to describe comprehensively all of the substantive concepts and skills that together constitute primary grade educational in the field of mathematics. Others respectively having knowledge of the teaching of language arts, science and social sciences, similarly develop master lists descriptive of the skills and concepts that make up the pedagogical programs in those fields. Preferably, the development of this master list of curriculum concept terms is carried out through careful and thorough analysis of a group of existing standards regimes that comprises every significant type and philosophy of standard setting, in order that the resulting master list comprise, as well as may be done, the denomination of each and every “skill” and substantive curriculum concept considered by any standard-setting body to be pertinent to the teaching of a particular field of study, at each grade level in the desired range (typically K-12).

Upon the completion of the master list described above, said list serves as a normalization table whereby both the detailed description of the substantive content of any educational product and each of the plurality of sets of educational standards (including their respective strands and substrands) may usefully be linked.

Thus, the curriculum standards of each individual state are manually translated into terms found in the master list of curriculum concepts and skills terms: For each state, each standard, standard strand, and standard substrands, is individually considered, and is re-stated into a listing of the master list terms addressed by the particular standard, strand or substrand. The resulting associations are stored on computer-readable media, subject to retrieval by search directed either to a selected standard, strand or substrand, or to a selected “skill” or curriculum concept term on the master list. For example, where the translation table may include the skill definition, in the language arts file, of “locating theme sentence in paragraph,” a search on that parameter would return an identification of each standard, standard strand, or substrands, in the curriculum standards set of a selected state, in which the skill or concept of “locating theme sentence in paragraph” is addressed. This deconstruction of state (and other) standards, their strands and substrands, into categories that correspond to terms found on a common master list of terms is performed for each and every state and other standard-setting body of interest.

In a similar fashion, but now addressing the educational products marketed by publishers specifically for use in state-regulated educational programs, the content of each such educational product is analyzed in detail and a listing is manually developed that identifies comprehensively each skill and curriculum concept appearing on the master list that is addressed in the selected product. A file containing the resulting associations is stored on computer-readable media.

Thus, and instead of attempting to link each of several thousand educational products individually, separately and directly to each of the standards, strands and substrands of some 50 states (together totaling some 57,000 separate standards provisions), the present invention links both the lists of standards substrands and the content-description lists of all products to a single central translation table.

Using the method of the invention, a search for products that meet the standards of any selected state for a selected subject and grade level is transmuted by the system into a search for all products that address those terms on a common master list that have been associated with the user's query. The system then searches the products database for all products having been assigned, by manual coding, the identical curriculum concept terms, and returns a list of all titles that address the matched terms.

In the preferred embodiment of the invention, which is directed to the field of the on-line marketing of educational software and other materials, as further described below, a user is presented, on the user's own computer display, with a screen displaying a plurality of drop-down menus and scroll boxes representing record fields or segments to be searched, including grade level range, subject classification, and a selection between searching by curriculum skill or by “state standard.”

The method comprises receiving a query from a user, said query identifying a grade level and a subject classification, and the particular state whose standards govern the user's curriculum requirements. Using the central normalization table referred to above to mediate links between curriculum concept identifiers pertaining to products carried on the web site catalog and curriculum concept identifiers pertaining to specific curriculum standards, strands and substrands selected by the user, the system then returns to the user a list of all catalog products that meet the curriculum requirements set forth in the state standards criteria selected by the user.

A major advantage of the system and method of the invention is that, when a state or other standard-setting body changes any one or more curriculum standards, strand and/or substrand, all that is necessary to update the searchable databases, in the system of the invention, is to update the master table entries associated with the amended substrands. All product link associations to such amended substrands are thereby automatically updated without need for any further action.

The present invention also addresses a secondary, but common, problem for users of a standards-based search system. This problem concerns the need for means for judging the quality of a reported match between a selected product and an applicable set of standards. The traditional approach of matching a product to a given standard, whereby a publisher simply reports an alleged match between its product and a given set of standards, which the user is commonly required to accept on faith, cannot produce a reliable quality rating.

By contrast the present invention provides users with an objective, quantitative index of a given product's capacity to address a state standards' substrand. Upon generating a list of products that match the specific curriculum requirements selected by a user as of principal interest, for a jurisdiction selected by the user, the present method readily provides means for allowing the user to view a list of all other state standards, strands and substrands which that product also addresses (with the substrand originally searched for being preferably highlighted).

The present invention may also advantageously be combined with other search techniques in a manner that greatly enhances its usefulness to users. In particular, and having provided the user with means to identify all products that meet the user's curriculum requirements (as such requirements may be set by a governmental agency in the user's home state), the present invention preferably also comprises means for addressing a wide variety of user preferences, including preferences that the user may not have been conscious of prior to prompting by the system.

For this purpose scroll box query terms are presented with corresponding check boxes that can be selectively marked or checked by the user, thereby adding terms to the query. The checking of any term in turn generally opens and presents to the user a new group of check boxes defining additional query terms, one or more of which may then also be checked by the user.

Thus the system of the invention preferably comprises, in addition to the standard-based search method described above, a plurality of hierarchically-organized categories of user preferences, against which the results list developed from a standard-based search may be mined, thereby narrowing the initially generated results list in accordance with the results of additional preference-based user queries.

For example the system of the invention may present the user with a query format whereby the user is prompted to make choices from pull-down menus setting forth short lists of preference-based categories, for example addressing topics such as “type of learning setting” and “preferred teaching style”. The system provides for the saving of search results at each step, whereby users may ascertain the effect, on numbers of “hits” remaining, upon making an additional filtering query. Thus, where the selection of a sharply-narrowing feature, such as “product provides on-line updates”, returns a “null” result (no products on the results list have that feature), the user may withdraw that selection criteria and return to an earlier results listing.

### DETAILED DESCRIPTION OF PREFERRED EMBODIMENT

The present invention provides a computerized search system for identifying catalog items that meet any selected one of a plurality of standards set by any one of a plurality of standard-setting bodies, using a central master list of terms to which each standard and each catalog item have been manually mapped by persons knowledgeable regarding the subject matters of said catalog items.

Upon the selection by the user of a standards regime, and of a specific activity that invokes one or more standards of said standards regime, say, the teaching of reading skills to 3d graders, in a school that is subject to California State educational standards, the system generates a list of any catalog items that comprise subject matter that address the same curriculum concepts as the California State curriculum standards for the teaching of reading skills to grade 3 students.

Because the contents of all catalog items have been categorized in accordance with a central master list of categorizing terms that is general in nature, and each standard of each standards regime has likewise been categorized using the identical master list of categorizing terms, any change in the contents of any standard that may be effected by any standard-setting body is readily implemented in the database simply by re-coding the particular standards affected by said change, and mapping the modified standard to the master list terms that correctly characterize said standard in its modified form.

The search method of the present invention may be implemented, for example, as part of a web site, an internet site, an on-line services network, or any other type of computer system that provides searching capabilities to a community of users with respect to a library or catalog of search objects that are subject to regulation or oversight by one or a plurality of standard setting regimes. Such standard setting regimes may be governmental, as is the case for example for public K-12 education, or the product of industry standard setting bodies, such as the National Council of Teachers of Mathematics.

In addition the method of the invention may readily be combined with other methods for refining search results, notably with methods for mining initially returned results, through additional guided search algorithms that concern other search parameters of interest to the particular community of users addressed by the system.

For purposes of illustration, the system is described herein in the context of a search engine that is used to assist customers of EduMatch, Inc. in locating items of educational software from an online catalog of such products. Throughout the description, reference will be made to various implementation-specific details of the EduMatch implementation. These details are provided in order to illustrate a preferred embodiment of the invention, and not to limit in any way the scope of the invention. The scope of the invention is set forth in the appended claims.

In a conventional and well known manner the EduMatch web site includes functionality for allowing users to search, browse and make purchases from an on-line catalog of educational software titles via the internet.

Because the EduMatch catalog of educational software products contains several thousand titles it is important for the site to provide an efficient mechanism for assisting users to locate items pertinent to their academic requirements.

An important characteristic of the community of users to which the EduMatch web site is addressed is that such users comprise primarily education professionals including K-12 classroom teachers and school administrators charged with purchasing textbooks and other teaching materials, including educational software, that complies with curriculum requirements and standards established by state agencies responsible for establishing and maintaining educational standards.

Accordingly the EduMatch web site must provide means for allowing users of the web site to identify catalog items that meet specific curriculum standards then in force in each of the 50 states in the United States. The web site must therefore provide means for matching the curriculum content of each title in the web site catalog with the curriculum standards that have been established in some fifty different states. Furthermore it is commonplace for the state educational agencies responsible for establishing educational standards to revise at least some of their curriculum standards periodically. As a result it is imperative, if the EduMatch web site is to meet the needs of its community of users, that the on-line catalog search system include means for easily updating its databases as needed to reflect any change by any state in any of its curriculum standards.

The means provided by the EduMatch web site search engine, for matching information regarding the content of thousands of educational software titles to the variegated and changing curriculum standards set by some fifty states, are readily adaptable to many other applications outside of the field of public education, in which it is also necessary to generate matches between a catalog of objects and a plurality of different sets of criteria for evaluating attributes of said objects.

The invention is intended to be implemented on a web site that includes a web server application capable of processing user requests received from user computers via the Internet, all in a conventional manner. The web server includes a query server to process user queries, and a number of databases. On the EduMatch web site such databases are maintained in Oracle-based environments, but the selection of a database environment is purely a matter of choice.

The EduMatch preferred embodiment of the invention employs six searchable base tables to support user queries.

The first base table, which is a central component of the invention, is the “Master” table, which includes a listing of all attribute parameters that are available for assignment to the product titles that make up the catalog of products marketed on the web site. The “Master” table thus comprises, importantly, a comprehensive listing of all of the curriculum concepts that may be encountered in each of the four main subject categories, Language Arts, Math, Science, and Social Studies, into which educators divide the public school curricula. In the “Master table a unique “skill_key” identifier, typically numerical in form, is assigned to each “curriculum concept,” and these “skill_key” identifiers collectively form a normalization table for linking state standards formulations of educational standards to the educational products that address these state standards.

The database of “curriculum concepts” that is stored in the “Master” table was developed by education professionals, from a thorough study of the curriculum requirements of a variety of states. The objective for developing this database was to obtain a complete map of the entire K-12 curricula using a single set of “curriculum concepts,” to which map there could then be matched both the respective standards promulgated by the 50 states and the contents of every published educational text or software product. (Preferably, a listing entitled “Skill Description” may be provided as part of the “Master” table, as ancillary to the “Curriculum Concept” entries, to contain and make available to users additional information regarding a given curriculum concept).

For example, the list of curriculum skills that may be addressed, in a science curriculum directed to the teaching of the properties of objects and materials to elementary school students, might include the following “key curriculum concepts” (to each of which, as shown, a unique numeric “skill_key” identifier is assigned for purposes of automated searching):

Properties of objects and materials:

331950 E-Materials can exist in different state—solid, liquid, and gases

332000 E-Objects are made of one of more materials, such as paper, wood, and metal.

332050 E-Observable properties—size, weight, shape, color, temperature, and the ability to react with other substances.

332100 E-Observable properties can be measured using tools such as rulers, ability to react with other substances.

332150 E-Some common materials, such as water, can be changed from one state to another by heating or cooling.

The educational standards of a given state might employ somewhat different terminology to describe the curriculum concepts set forth above. Where a substrand of a state's educational standards required fourth grade science textbooks to cover the several aspects of the properties of matter set forth in the above listing, however, that substrand, upon manual analysis by trained coders, would be assigned the “skill_key” identifiers set forth above, to represent the five “curriculum concepts” set forth above. Similarly, a 4t grade educational software title that addressed the first, second and fourth of these curriculum concepts would, in the “curriculum concepts” data field of a suitable database (the “Title Skills Cross-Reference” table, in the EduMatch preferred embodiment), be assigned the “skill_keys” associated with said first, second and fourth concepts. Thereafter, any search by a user that selected, as a search criteria, that state's substrand specifying (however stated in the state standard) the study of the properties of materials, would return a list of elementary school educational software products that cover the properties of materials, including the title that addresses some but not all of the “curriculum concepts” addressed in the selected state standard substrand.

Thus, upon dissecting a state standard into a set of “curriculum concepts” selected from the larger set of curriculum concepts listed in the “Master” table, and assigning to each strand and substrand of that state standard the one or more “skill_keys” that represent the “curriculum concepts” addressed in each particular standard strand and substrand, a link may readily be effected by the computer to the educational product titles to which the identical “skill keys” have been assigned through a similar process of dissection.

In addition to its listings of “curriculum concepts” and of uniquely matching “skill keys,” the “Master” table also contains similar listings, and uniquely matching “skill_keys,” for the attribute categories of product “Features”, “Bonus Skills,” and “Tools,” by which a catalog title may also be characterized. These additional categories of attributes are briefly and generally described below.

The “Bonus Skills” field contains entries such as the following: “Artistic Creativity,” “Auditory Skills,” “Categorizing,” “Following Directions,” “Making choices, “Problem Identification,” “Spatial Skills,” “Using Tools,” and “Working with Others.” The “Features” attribute fields are sufficiently numerous that they are preferably organized hierarchically under a small group of top-level categories such as the following:

What kinds of students do you have?

In what type of learning setting will the software be used?

What teaching style do you like in software?

What student management features do you want?

What program management features do you want?

What software features should be included?

What do you want as special needs features?

Do you want some foreign language content?

By way of illustration, the top category “What kind of students do you have? within the “Features” listings itself comprises the following fields:

On grade level

Title 1

At-Risk

Adult Education

ESL

And the “What type of learning setting top-level “features” category includes the following fields:

Computer Lab

Whole Class (Teacher Directed)

Small Group Learning

Single Computer Classroom

Individual Study (Student Directed)

Comparable listings of subsidiary fields are provided for the other top level “Features” categories.

A “Tools” category of attribute fields is also contained in the “Title Skills Cross-Reference” table. This category is directed to product attributes such as “Gradebook Generator,” “Multi-Media Resources,” “Reference Tool,” “Test Generator,” and “Worksheet Generator.”

A second base table, the “Titles” table, includes an entry for each title in the web site catalog, and it comprises, for each title, the following data fields: “Titles”, “Title_Key”, “Start Grade” and “End Grade.” For each product in the catalog, the “Titles” field contains the published title of the product; the “Title_Key” field contains a unique numerical identifier; and the “Start grade” and “End grade” fields set forth the school grade levels to which the product is addressed. Preferably, a database of html pages containing graphically presented information regarding each catalog title is linked to the “Titles” table, whereby users may view, for any selected title, bibliographic information, an image of the product packaging, price information, edition information and any pertinent technical information specific to the product.

A third base table is an “Items” table. This table contains, again for each title in the catalog, a series of searchable attribute fields directed to technical and bibliographic features associated with the catalog products, including for example “edition,” “medium” (e.g., CD-rom versus 3.5 diskette), and “technical specs” (e.g., PC only, PC and Macintosh, etc.). A “title key” field enables intersection of the “Items” table with other tables comprising data regarding the catalog object tables.

A fourth base table, the “Title Skills Cross-Reference” table, contains a copy of the “title_key” list and a series of searchable fields for storing attributes of each object in the product catalog, principally including the “curriculum concept” attributes that define the substantive pedagogical content addressed in any specific product. The attribute fields in the “Title Skills Cross-Reference” table thus include a “curriculum concept” field, in which there is stored, for each catalog product, a separate entry for each curriculum concept that is addressed in that particular product, and, associated with each such “curriculum concept” entry, there is a matching entry in a “skill_key” field, containing the unique numerical identifier that, in all pertinent databases, is associated with and represents a given “curriculum concept.” Additional object attribute fields in the “Title Skills Cross-Reference” table, store data, for each catalog product “object”, regarding other searchable attributes that a catalog product may have. These attribute fields include a “Bonus Skills” field, a “Features” field, and a “Tools” field.

The “Title Skills Cross-Reference” table, in the computerized embodiment of the invention, includes a searchable “title_key” field and a searchable “skill_key” field, thereby enabling the intersection of this table with the “Title” table and with the “State Standards” table that is described below.

The raw data comprising the “Title Skills Cross-Reference” table, including the data for the “Bonus Skills,” “Features,” and “Tools” attribute fields, are preferably collected, for each product in the catalog, by trained coders knowledgeable in the pertinent field of education. The coders fill out a “check-off” questionnaire that lists all pertinent attributes of possible interest to the educational community to which the web site is addressed. Each coder is thus provided with a form questionnaire containing a listing of all curriculum concepts for the applicable subject matter (i.e., Language Arts, Math, Science, or Social Sciences), all product “features”, all permutations of product “technical specs”, and all categories of useful pedagogical “tools”, that the product might address. (Preferably, of course, such a questionnaire also provides a means for the coder to report any “curriculum concept”, or of any feature of possible interest to a purchaser, which the provider of the questionnaire had not included, in order that the quality and completeness of the questionnaire may be improved).

A fifth base table, the “State Standards” table, contains data regarding the educational standards promulgated by the different states, and this table preferably contains the complete text of all educational standards promulgated by all of the states having such standards. The “State Standard” table preferably contains the following searchable attribute fields: “state”, “subject,” “standard,” “strand,” “substrand,” “start grade,” “end grade,” and “standard key.” Hierarchically organized by state, the “State Standards” table permits users to locate, by subject (Language Arts, etc.) and by grade level, the text of the educational standards applicable in any given state. Within each educational subject, the applicable standards, strands and substrands are organized hierarchically. Preferably the query server employed by the system permits the state standards data in this table to be presented to the user in a format that provides checkboxes for user selection of displayed standards. The check off by the user of the box adjoining a given standard strand may then function both to select a strand and to open a listing of the substrands subsidiary to that specific strand, again in a check box format. In that manner the user may select any specific strands and substrands as elements of a search query against the educational product data base on the web site. A unique “standard_key” identifier is associated with each standard, strand and substrand of each state, and serves to define a user's search query when the corresponding standard, strand or substrand is selected by the user.

The sixth and last base table employed by the preferred embodiment of the invention is a “State Standards Skills Cross-Reference” table. This table contains the data required to cross-reference each standard, strand and substrand, of each state's educational standards, to the “Curriculum Concept” map stored and maintained in the “Master” table. That is, the “State Standards Skills Cross-Reference” table contains an entry, for each substrand of each strand of each standard of each state (each strand and substrand being represented on this table by its unique “standard_key” identifier), identifying the “skill_key” corresponding to each of the normalized “curriculum concepts” that is invoked by the selected substrand. The “State Standards Skills Cross-Reference” table thus contains a comprehensive list of all of the “standard_keys” assigned to components of the state standards, and, for each such “standard_key,” it contains a listing of all “skill_keys” that represent “curriculum concepts” that have been assigned to the educational standard represented by that “standard_key.” The correct cross-referencing of particular educational standards to particular curriculum concept, as embodied on the “State Standards Skills Cross-Reference” table, is a crucially important task, which in the first instance is preferably performed manually by education professionals or under the close supervision of education professionals. This cross-referencing task requires the mapping of each strand and substrand of a state's educational standards to the map of “curriculum concepts” that is stored and maintained in the “Master” table.

While different states organize their educational standards in varying ways, and often use different vocabularies to address similar educational subjects, substantially all state educational standards are detailed and voluminous, and break down each educational subject matter into hierarchies that include standard “strands” and, as sub-categories of standard strands, substrands. Even so, each substrand of each strand will generally invoke a plurality of curriculum concepts. Accordingly, the coding of a state standard for inclusion in the “State Standards” table will generally result in the assignment, for each of most substrands in each substrand of each standard, of a plurality of “curriculum concepts” and their uniquely associated “skill keys.”

It is an important advantage of the present invention that a change in any state standard may be implemented readily and efficiently by the system, and does not require any modification of the coding of the product-related tables. All that is needed to modify the applicability of all catalog products to account of a change in a state's standards is simply to recode the “curriculum concept” assignments pertaining to the modified standard. Thus, where a state may add a curriculum concept to a particular standard substrand, it suffices simply to add the “skill_key” identifier associated with that additional curriculum concept to the listing of that substrand on the “State Standards Skills Cross-Reference” table. Thereupon, any product search based on the modified standard substrand will include a query component requiring the inclusion of the added curriculum concept.

A user may search the EduMatch catalog of educational software titles in any of several ways. Besides searching by product title, where it is known, the user may search either by curriculum concept of by “state standard”. Where the user seeks to identify all titles that address the educational standards of the user's state, for the specific topic taught by the user, for example, the program permits the user to specify the state of interest, the general subject matter (Language Arts, Math, Science and Social Sciences) and a grade level or range of grade levels. The program then presents the user with a hierarchical listing of the curriculum standards, strands, and substrands that are applicable in the selected state to the selected subject matter. This listing is preferably presented to the user in a check box format, permitting the user to select the particular strands and substrands of interest.

Upon the submission by the user of a search request that identifies specific curriculum strands and substrands, the system operates, principally by intersecting the “State Standards Cross-Reference” table and the “Title Skills Cross-Reference” table, to return a list of all catalog titles that address the educational standards selected by the user. The user's selection of specific educational standards effects the formation of a search query incorporating the “standard key” identifiers associated with the selected standards. These “standard key” identifiers, when intersected with the “State Standards Cross-Reference” table, produce a list of “skill key” identifiers corresponding to the “curriculum concepts” invoked by the selected state standards. This set of “skill key” identifiers is then applied to the “Title Skills Cross-Reference” table, and returns a list of all “title_keys” associated with any of said “skill_keys.” These “title_keys” are in turn each associated, on the “Titles” table, with a catalog title, and the search thus proceeds to return a list of all catalog titles addressing the educational standards selected by the user. At this point the user may either view an html page containing graphically presented information regarding any of the listed titles, or further refine the search. Means are provided, in a conventional manner, for a user to enter purchase instructions regarding any title.

Where the user seeks to undertake a search by curriculum concept, the program presents to the user a hierarchically organized listing of all curriculum concepts stored and maintained in the “Master” table, grouped hierarchically under the four principal subjects of Language Arts, Math, Science and Social Sciences.

Upon the submission by the user of a search request that identifies one or more specific curriculum concepts, from a listing of curriculum concepts generated from the “Master” table, the system employs the “Title Skills Cross-Reference” table to return a list of all catalog titles that address the selected curriculum concepts. Specifically, the user's selection of specific curriculum concepts effects the formation of a search query incorporating the “skill_key” identifiers associated with the selected curriculum concepts, and said “skill_key” identifiers, when intersected with the “Title Skills Cross-Reference” table, function to produce a list of all “title_keys” associated with any of said “skill_keys.” These “titlekeys” are in turn each associated, on the “Titles” table, with a catalog title, and the search thus proceeds to return a list of all catalog titles addressing the curriculum concepts selected by the user.

As earlier noted, the present invention also addresses the desire of many users for means for judging the quality of matches between the products returned on the results list and the set of standards applicable to the user. Publishers have traditionally dealt with this concern simply by reporting whether or not a given product satisfies the curriculum standards set by this or that state for the subject and grade level to which the product is addressed.

By contrast the present invention permits users to view a precise listing of all standards, strands and substrands, for the state selected by the user, which a selected product addresses, with the substrand originally searched for by the user being preferably highlighted. Each identified substrand may readily be provided with a ‘relevancy rating’ (say, from “weak” to “fair” to “good”) indicating that product's depth of coverage of that substrand, using the following methodology.

As previously described, a search on a given substrand of a state standard will return a list of all products that are linked to any of the “curriculum concepts”, in the “Master” table, that are also linked to the user-selected substrand, in the manner described above. However a substrand may, and generally it does, invoke a number of different key curriculum concepts. For example, in a example cited previously, a 4th grade Science substrand directed to the properties of objects and materials was assigned five separate “skill_keys” corresponding to five separate “curriculum concepts” related to the broader topic of “properties of objects and materials.” In the same example, a catalog title addressing three of those five curriculum concepts was accordingly assigned the three “skill_keys” corresponding to those concepts.

A search directed to that state standards substrand might uncover a dozen titles addressing one or more of the five “curriculum concepts” (and thus “skill_keys”) assigned to that substrand. A title sharing all five “skill_keys” would automatically be given a “good” relevance rating. Another sharing but one “skill_key” would be given a “weak” relevance rating. The query server program can readily be adjusted, using well known conventional techniques, to return a “fair” rating when a title falls within a set min-max proportion of possible “skill_key” matches.

In general a “good” rating should be assigned by the query server program where a product under consideration by the user links to most or all of a selected substrand's assigned curriculum concepts, a fair” rating to products addressing an average number of concepts linked to the selected substrand, and a “weak” rating for products having a yet lesser proportion of linked concepts. This means for rating the significance of matches allows the user to compare the products returned by a search with each other, specifically with respect to how thoroughly they address the substrand chosen.

Also as earlier noted, the present invention may advantageously be combined with a variety of other search techniques in order to enhance the usefulness of the search engine to users. A particularly desirable combination, in tandem with the aforesaid means for identifying the products that meet the user's curriculum requirements, are additional search techniques which address user preferences. It has been found particularly desirable to incorporate in the search engine of the invention means for prompting the user with suggested queries that address preference attributes of which the user may have been only dimly aware, if at all.

For this purpose it is desirable to incorporate in the system of the invention suitable means for the user to enter queries concerning a plurality of hierarchically-organized categories of user preferences, and means for searching against which the results list developed from a standard-based search may be mined, thereby narrowing the initially generated results list in accordance with the results of additional preference-based user queries.

In the preferred embodiment exemplified by the EduMatch web site, the user search screen comprises (in addition to the standard-based search query menus) several query menus in the form of scroll boxes, that enable the user to conduct, and to intersect with the results of a standard-based search, several guided searches addressing preference attributes.

In assembling and organizing a set of preference-based categories and user queries, intended to guide an on-line user to make purchase decisions that effectively address genuine user preferences, the vast number of preference considerations that may be at play must be carefully considered. Over one hundred such considerations were thus identified as pertinent to the marketing of the educational software in the EduMatch catalog, principally including preferences concerning teaching style, inclusion of pedagogical enhancements such as practice questions, and usability by handicapped or at risk students.

Experience has thus shown that the construction of a hierarchical list of search criteria to address such preference considerations is a difficult task, particularly absent reliable knowledge regarding the order of importance of various preferences, or of any particular combination of preferences, to the individual user. In particular it is often the availability of a combination of factors that determines the importance of each of a group of individual factor (i.e. “if I can get (a),(b), and (d), I'd also prefer (m) and (q), but if I can't have (b), I need (x) and (y), and maybe also (t)”). Furthermore the exercise of preference decisions is often affected, in the educational products field to which the preferred embodiment of the invention is directed, by the results of the initial curriculum standards-based search; thus a user's real preferences might be (whether or not the user is truly aware of it, absent guided prompting): “For strand 1, I want (a)(“illustrated examples”),(b)(“practice questions”), and (d)(“reward games”), plus (m) and (q), but for strand 2, I must have (d) and (e)(“saves student work”) and would like (t) and (z)”.

A still further complicating factor, in searching for “the right product,” is that the typical user generally has a clear awareness of a set of ‘must have’ criteria (“I need software that runs under Windows and comes with a teacher's guide, and I won't buy anything that does not keep student records”), and, in addition, a vague awareness of other pertinent information, previously encountered but not currently in mind, that the user will recall upon presentation (“Oh yes, I read somewhere that learning games have a better success ratio than reward games”). The introduction of still additional criteria, that may be entirely new to the user, could be the key to the decision making process (“I had no idea that there is software where I could add my own content . . . I want that!”).

One common way of presenting secondary search criteria to on-line users of a merchant web site is in the form of an undifferentiated “check box” listing of criteria. Where it includes numerous criteria, including arguably ‘fuzzy’ criteria of no particular interest to most users, such a list can easily be confusing to the user, it is time-intensive to complete, and, for the conscientious user who does go down the whole list, it is often a set-up for a “null” result, returning no matching products. The other common way of presenting secondary search criteria to on-line users is a hierarchically-organized listing, but that approach may cause many users to quit the search process prematurely, notably if a category of potential importance to that user is not close to the top of the list. And again, the user who does proceed through the entire hierarchical listing may leave frustrated if faced at the end with a “null” result.

In the preferred embodiment of the present invention, the user who has already undertaken a curriculum standards-based search, as aforesaid, is provided with means for applying preference-based criteria to the initial results list, through the following modified hierarchical approach. A pull-down menu (entitled, in the EduMatch examplar, “Make this work for me”) presents the user with several easy-to-understand categories, including “Features”, “Bonus Skills,” “Tech Specs,” “Edition,” and “Medium.” Of these, the “Features” category provides some of the more subjective or “fuzzy” factors, yet these may be of critical pedagogic importance to many teachers. The category “Features” thus includes one sub-category of like items (i.e. “In what type of learning setting will the software be used?” or “What teaching style do you like in software?”), plus a sub-sub category of like items that change depending on the user's choice of the first subcategory. In either case, the user has only to pick from a short list of categories and subcategories, the importance of which is easily established.

Three of the other non-curriculum related categories (“Edition”, “Medium” and “Bonus Skills”) each produces a simple list of like criteria from which to choose. A category entitled “Tech Specs” includes two sub-categories of like items (“Kind of Computer” and “Options you'd like to specify”), and also a sub-category of like items that change depending on the input responsive to the first two subcategories.

By using a drill-down technique that retains previously-used search criteria, the search results may be made a part of the decision-making process The user can at any time submit a new search criteria in order to consider the effect of the newly selected criteria on the results list, and then return to the previously obtained results. At any point the user may see how many products the search engine will return when combining all criteria of possible interest, inspect the list of products returned, and even look at specific products, their descriptions, reviews, state standards, features etc. At all times there is a clear path to resume the search process, whether the user wishes to further narrow down the presented choices, or to deselect a previous choice of criteria in favor of others (as, for example, the solution to the wish list “if I can have (a),(b), and (d), I'd also like (m) and (q), but if I can't have (b), I need (x) and (y), and maybe also (t)”).

A major problem addressed by the present invention, therefore, is that of winnowing an overlarge results list by generating so-called “related query terms” that assist the user in mining the initially returned result list. In the present invention, related query terms are generated by presenting the user with a plurality of new search domains, concerning features that are usually of great interest to the user although they differ in kind from the state regulated “curriculum concept” search domains that are the principal objective of the present invention.

As was the case with the coding of both state standards and product content, relative to the “curriculum concept” master list, the development of the preferences-based categories is also implemented by manual coding preferably carried out by persons experienced in the field of public education, and thus having a strong sense of the non-curriculum related factors that are important to educators.

The user of the present invention is provided with great flexibility in search navigation, as the program saves each search submission and its results, enabling the user either to broaden a search result, by returning to a prior search stage and withdrawing a previously selected query term (and possibly substituting another query term), or to narrow the results list by adding query terms selected either by drilling further down previously selected search categories, or, by entering query terms drawn from search parameters not previously entered.

Thus a user whose search for a language arts product of 3d graders, who initially also specified a preference for products comprising “reward” based incentives, may, on returning no hits or only a few hits, withdraw the specification of “rewards” feature, and, by repeating the search, immediately determine the effect that the additional specification of this single feature has on the query results.

Having now defined a preferred embodiment, variations that do not depart from the spirit of the invention will become apparent to those skilled in the art. The invention is thus not limited to the preferred embodiment, but is instead set forth in the appended claims and legal equivalents thereof.

What is claimed is:

1. A computer system for searching an object catalog subject to a plurality of standard-setting regimes, said computer system comprising:
(a) a first normalization table comprising a manually developed master list of terms that collectively map subject matter common to attributes of each object in said object catalog and to attributes of each of said plurality of standard-setting regimes;
(b) a second table comprising a manually developed listing of attributes of each object in said object catalog, each of said attributes being defined by a term selected from said master list; and
(c) a third table comprising a manually developed listing of attributes of each of said plurality of standard-setting regimes, each of said attributes being defined by a term selected from said master list.

2. The computer system claimed in claim 1 wherein said first normalization table further comprises, for each term in said master list, an associated unique numeric identifier.

3. The computer system of claim 2 further comprising a fourth table comprising, for each object attribute in said second table, the numeric identifier uniquely associated with the master list term that defines said object attribute, and a fifth table comprising, for each attribute of each of said plurality of standard-setting regimes, the numeric identifier uniquely associated with the master list term that defines said attribute.

4. The computer system of claim 3 further comprising query server means that permits a user to locate that set of objects in said object catalog which concern the subject matter of any user-selected standard in any of said plurality of standard-setting regimes.

5. The computer system of claim 3 further comprising means for access to said computer system over the internet by a community of users.

6. The computer system of claim 4 wherein said object catalog comprises data regarding published educational materials and said plurality of standard-setting regimes comprises at least one set of educational standards promulgated by a state agency.

7. The computer system of claim 5 further comprising searchable databases of user preferences categories, whereby users may submit search queries to be intersected against the results list of user searches directed to catalog objects that satisfy user-selected educational standards criteria.

8. The computer system of claim 6 wherein said computer system comprises means for saving user submitted search queries, and for modifying and re-entering previously submitted search queries

9. A method for searching an object catalog that is subject to a plurality of standard-setting regimes, comprising the steps of:
(a) manually developing a master list of terms that collectively map subject matter common to attributes of the objects in said object catalog and to attributes of each of said standard-setting regimes;
(b) manually developing a listing of attributes of each object in said object catalog, each of said attributes being defined by a term selected from said master list;
(c) manually developing a listing of attributes of each of said plurality of standard-setting regimes, each of said attributes being defined by a term selected from said master list.

10. The method of claim 9 further comprising the steps of:
(a) inputting said master list into a computer system, in a normalization table in said system that further comprises, for each term on said master list, an associated and unique numerical identifier;
(b) inputting said listing of attributes of catalog objects into a computer system, in a table in said system that further comprises, for each term in said listing of attributes of catalog objects, the numerical identifier associated with said term on said normalization table; and
(c) inputting said listing of attributes of standard-setting regimes into a computer system, in a table in said system that further comprises, for each term in said listing of attributes of standard-setting regimes, the numerical identifier associated with said term on said normalization table.
